(19) United States
(12) Patent Application Publication
(10) Pub. No.: US 2018/0131041 A1
(43) Pub. Date: May 10, 2018

(54) LITHIUM SALT GRAFTED NANOCRYSTALLINE CELLULOSE FOR SOLID POLYMER ELECTROLYTE

(71) Applicant: Blue Solutions Canada Inc., Boucherville (CA)

(72) Inventors: Frederic COTTON, Montreal (CA); Patrick LEBLANC, Boucherville (CA); Alain VALLEE, Varennes (CA); Brieuc GUILLERM, Montreal (CA)

(73) Assignee: Blue Solutions Canada Inc., Boucherville (CA)

(21) Appl. No.: 15/702,306

(22) Filed: Sep. 12, 2017

Related U.S. Application Data
(60) Provisional application No. 62/419,672, filed on Nov. 9, 2016.

(51) Int. Cl. H01M 10/0565; H01M 4/134; H01M 10/0525

(52) U.S. Cl. CPC H01M 10/0565; H01M 2300/0082; H01M 10/0525; H01M 4/134

(57) ABSTRACT

A solid polymer electrolyte for a battery is disclosed. The solid polymer electrolyte includes a polymer capable of solvating a lithium salt, a lithium salt, and nanocellulose in the form of nanofibers or nanocrystals onto which are grafted anions of lithium salt, the nanofibers or nanocrystals cellulose providing increased mechanical strength to the solid polymer electrolyte to resist growth of dendrites on the surface of the metallic lithium anode.

### FIELD OF THE INVENTION

The present invention relates to a lithium salt grafted nanocrystalline cellulose and more specifically to a solid polymer electrolyte containing the lithium salt grafted nanocrystalline cellulose which provides increased mechanical resistance and improved ionic conductivity. Lithium batteries fabricated with such electrolyte benefit from a longer cycle life.

### BACKGROUND OF THE INVENTION

A lithium battery using a lithium metal as a negative electrode has excellent energy density. However, with repeated cycles, such a battery can be subject to dendrites' growths on the surface of the lithium metal electrode when recharging the battery as the lithium ions are unevenly re-plated on the surface of the lithium metal electrode. To minimize the effect of the morphological evolution of the surface of the lithium metal anode including dendrites growth, a lithium metal battery typically uses a solid polymer electrolyte as described in U.S. Pat. No. 6,007,935 which is herein incorporated by reference. Over numerous cycles, the dendrites on the surface of the lithium metal anode may still grow to penetrate the electrolyte even though the electrolyte is solid and cause ‘soft’ short circuits between the negative electrode and the positive electrode, resulting in decreasing or poor performance of the battery. Therefore, the growth of dendrites may still deteriorate the cycling characteristics of the battery and constitutes a major limitation with respect to the optimization of the performances of lithium batteries having a metallic lithium anode.

Thus, there is a need for a solid electrolyte with increased mechanical strength which is also adapted to reduce or inhibit the effect of the growth of dendrites on the surface of the metallic lithium anode.

### STATEMENT OF THE INVENTION

One aspect of the present invention is to provide nanocrystalline cellulose (NCC) grafted with anions of lithium salt. In a preferred embodiment, the grafted anions of the lithium salts is LiSalt selected from the group consisting of SO₂NLiSO₂R, SO₂CLiRSO₂R or SO₂BLiSO₂R. In a further preferred embodiment, the grafted anions of the lithium salt is LiTFSI.

Another aspect of the present invention is to provide a solid polymer electrolyte for a battery, the solid polymer electrolyte including a polymer capable of solvating a lithium salt, a lithium salt, and nanocellulose in the form of nanofibers or nanocrystals onto which are grafted anions of lithium salt, the nanofibers or nanocrystals cellulose providing increased mechanical strength to the solid polymer electrolyte. The grafted anions improve the compatibility between the nanocrystalline cellulose and the various polymers thereby improving the dispersion of the nanocrystalline cellulose in the polymers blend. The grafted anions also improve the electrochemical performance by increasing the lithium ions transference number. The nanocellulose performance in the solid polymer electrolyte is improved by the attachment of ionic groups which add an ionic conductivity component to the nanocellulose while improving the mechanical strength of the solid polymer electrolyte.

Another aspect of the invention is to provide a solid polymer electrolyte for a battery, the solid polymer electrolyte including a polymer capable of solvating a lithium salt, a lithium salt, and nanocellulose in the form of nanofibers or nanocrystals onto which are grafted anions of lithium salt. In a specific embodiment, the nanocrystalline cellulose (NCC) is grafted with anions of LiTFSI salt.

Another aspect of the invention is to provide a solid polymer electrolyte for a battery, comprising a nano-composite comprising poly (ethylene oxide) chains blended with a nanocrystalline cellulose (NCC) onto which are grafted anions of lithium salt.

Another aspect of the invention is to provide a battery having a plurality of electrochemical cells, each electrochemical cell including a metallic lithium anode, a cathode, and a solid polymer electrolyte positioned between the anode and the cathode, the solid polymer electrolyte including a polymer capable of solvating a lithium salt, a lithium salt, and a nanocrystalline cellulose onto which are grafted anion of lithium salt, the nanocrystalline cellulose providing increased mechanical strength to the solid polymer electrolyte to resist growth of dendrites on the surface of the metallic lithium anode.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects and advantages of the embodiments of the present invention will become apparent from the following description, the accompanying drawings and the appended claims.

### BRIEF DESCRIPTION OF THE DRAWINGS

For a better understanding of the present invention as well as other aspects and further features thereof, reference is made to the following description which is to be used in conjunction with the accompanying drawings, where:

FIG. 1 is a schematic representation of a plurality of electrochemical cells forming a lithium metal polymer battery;

FIG. 2 schematically illustrates of three specific synthesis routes to graft a LiTFSI salt onto a nanocrystalline cellulose (NCC);

FIG. 3 is a schematic illustration of the RAFT/MADIX pathway of the first synthesis route (1) shown in FIG. 2;

FIG. 4 is a schematic illustration of the ARTP pathway of the first synthesis route (1) shown in FIG. 2;

FIG. 5 is a schematic illustration of the NMP pathway of the first synthesis route (1) shown in FIG. 2;

FIG. 6 is a list of the molecules A involved in the second synthesis route (2); and

FIG. 7 is a chemical representation of the molecules A and B involved in the third synthesis route (3) shown in FIG. 2.

### DESCRIPTION OF PREFERRED EMBODIMENT(S)

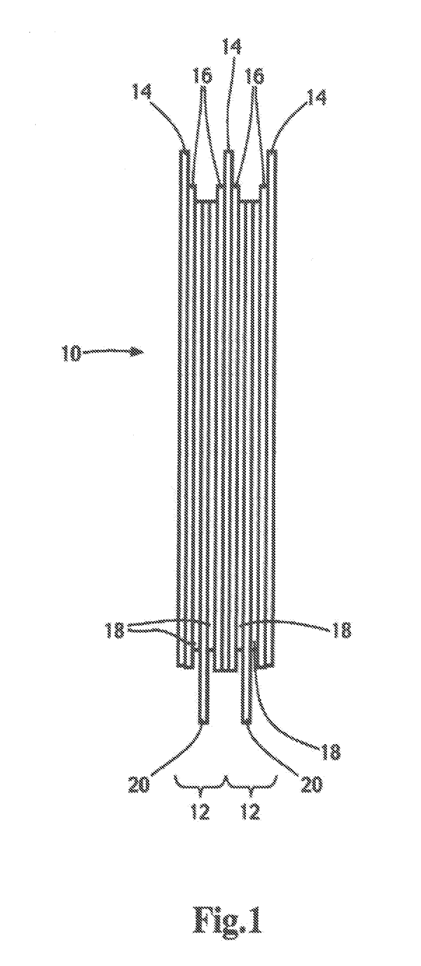

FIG. 1 illustrates schematically a lithium metal polymer battery 10 having a plurality of electrochemical cells 12 each including an anode or negative electrode 14 made of a sheet of metallic lithium, a solid electrolyte 16 and a cathode or positive electrode film 18 layered onto a current collector 20. The solid electrolyte 16 typically includes a lithium salt to provide ionic conduction between the anode 14 and the cathode 18. The sheet of lithium metal typically has a thickness ranging from 20 microns to 100 microns; the solid electrolyte 16 has a thickness ranging from 5 microns to 50 microns, and the positive electrode film 18 typically has a thickness ranging from 20 microns to 100 microns.

The lithium salt may be selected from LiCF₃SO₃, LiB(C₂O₄)₂, LiN(CF₃SO₂)₂, LiC(CF₃SO₂)₃, LiC(CH₃)(CF₃SO₂)₂, LiCH(CF₃SO₂)₂, LiCH₂(CF₃SO₂), LiC₂F₅SO₃, LiN(C₂F₅SO₂)₂, LiN(CF₃SO₂), LiB(CF₃SO₂)₂, LiPF₆, LiSbF₆, LiClO₄, LiSCN, LiAsF₆, LiBOB, LiBF₄, and LiClO₄.

The internal operating temperature of the battery 10 in the electrochemical cells 12 is typically between 40° C. and 100° C. Lithium polymer batteries preferably include an internal heating system to bring the electrochemical cells 12 to their optimal operating temperature. The battery 10 may be used indoors or outdoors in a wide temperature range (between −40° C. to +70° C.).

The solid polymer electrolyte 16 according to the invention is composed of nano-composite comprising polyethylene oxide chains blended with a nanocrystalline cellulose onto which is grafted anions of lithium salt. Nanocrystalline cellulose grafted with anions of lithium salt are used as an additive to the polyethylene oxide-Li salt complex of the solid polymer electrolyte 16 in order to increase the mechanical properties of the solid polymer electrolyte 16 and to improve the ionic conductivity of the solid polymer electrolyte.

Nanocrystalline cellulose are extracted as a colloidal suspension from chemical wood pulps, but other cellulosic materials, such as bacteria, cellulose-containing sea animals (e.g. tunicate), or cotton can be used. Nanocrystalline cellulose consist of chains of D-glucose units which arrange themselves to form crystalline and amorphous domains. Nanocrystalline cellulose comprise crystallites whose physical dimension ranges between 5-10 nm in cross-section and 20-100 nm in length, depending on the raw material used in the extraction. These charged crystallites can be suspended in water, or other solvents if appropriately derivatized, or self-assembled to form solid materials via air, spray- or freeze-drying. When dried, nanocrystalline cellulose form an agglomeration of parallelepiped rod-like structures, which possess cross-sections in the nanometer range (5-20 nm), while their lengths are orders of magnitude larger (100-1000 nm) resulting in high aspect ratios. Nanocrystalline cellulose are also characterized by high crystallinity (>80%, and most likely between 85 and 97%) approaching the theoretical limit of the cellulose chains.

The nanocrystalline cellulose (ungrafted), if correctly dispersed, provides increased mechanical strength to the solid polymer electrolyte 16 but do not participate in the ionic conduction between anode 14 and cathode 18 and even hinder ionic conduction since lithium ions must bypass the nanocrystalline cellulose in their migrations back and forth through the solid polymer electrolyte 16 between anode 14 and cathode 18 during charge and discharge.

To alleviate the hindrance of the nanocrystalline cellulose to the ionic conduction of the solid polymer electrolyte 16, anions of lithium salt are grafted onto the nanocrystalline cellulose, the grafted anions providing an ionic conducting path for lithium ions migrating through the solid polymer electrolyte 16 instead of hindering their migration. The grafted anions also improve the electrochemical performance of the solid polymer electrolyte by increasing the lithium ions transport number. The behavior of the nanocellulose in the solid polymer electrolyte is improved by the attachment of anionic groups which add an ionic conductivity component to the nanocellulose while improving the mechanical strength of the solid polymer electrolyte.

The grafted anions of the lithium salts LiSalts previously described, which provide the ionic path through the nanocrystalline cellulose of the solid polymer electrolyte 16, are respectively SO₂NLiSO₂R, SO₂CLiRSO₂R or SO₂BLiSO₂R. R may be a linear or cyclic alkyl or aryl or alkyl fluoride, an ether, ester, amide, thioether, amine, quaternary ammonium, urethane, thiourethane, silane or a mixture of these groups. R may also be an hydrogen or a fluorine atom or a chlorine atom or a bromine atom or an iodine atom.

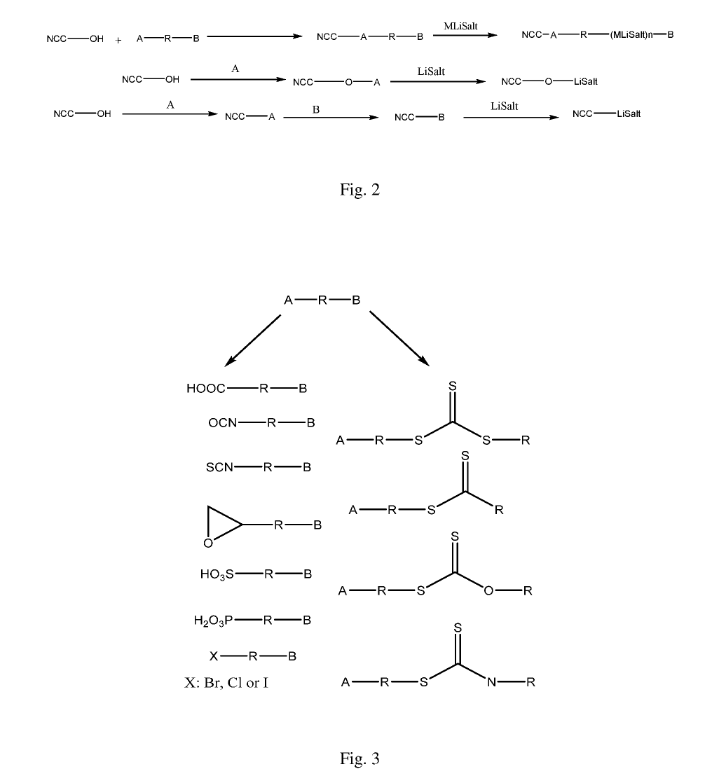

In order to graft a lithium salt to the nanocrystalline celluloses (NCC), many synthesis routes are possible. For example, there are three specific routes to graft the anion of the lithium salt LiSalt as illustrated in FIG. 2. The first route (1) is a two-stage process wherein the first stage is the grafting onto the NCC—OH of a polymerisation agent A-R-B. The second stage is the polymerization of a monomer containing an anion of lithium MLiSalt salt to obtain NCC-A-R-(MLiSalt)n-B.

The second synthesis route (2) is also a two stages process. In the first stage, a grouping A is grafted onto the NCC—OH to obtain CNC—O-A. In the second stage, the anion of lithium salt is grafted to obtain NCC—O-LiSalt. R may be a linear or cyclic alkyl or aryl or alkyl fluoride, an ether, ester, amide, thioether, amine, quaternary ammonium, urethane, thiourethane, silane or a mixture of these groups.

The third synthesis route (3) is a three stages process. In the first stage, a group A is grafted onto the NCC—OH to obtain NCC-A. The NCC-A is then transformed into NCC—B. Finally, the anion of lithium salt is formed to obtain NCC-LiSalt.

There are three possible pathways with regards to the first synthesis route (1): The pathway called RAFT/MADIX (radical addition-fragmentation chain transfer/macromolecular design via reversible addition-fragmentation chain transfer), the pathway called ATRP (atom transfer radical polymerization) and the pathway called NMP (nitroxide mediated polymerization). With reference to FIG. 3, the first stage of the RAFT/MADIX pathway brings to play a molecule comprising a function B which may be a trithioester, a dithioester, a xanthate or a dithiocarbamate and also a function A of the type carboxylic acid and its salts, isocyanate, thioisocyanate, oxirane, sulfonic acid and its salts, phosphonic acid and its salts, or halide (X: Cl, I or Br) which can react with the alcohol group of the NCC—OH. The second stage of the RAFT/MADIX pathway is the radical polymerization of a monomer carrying an anion of lithium salt and a reactive group in the radical polymerization. The reactive group M of the monomer MLiSalt in the radical polymerization can be for example a vinylphenyl substituted in ortho, meta or para position, an acrylate, a methacrylate, an allyl or a vinyl.

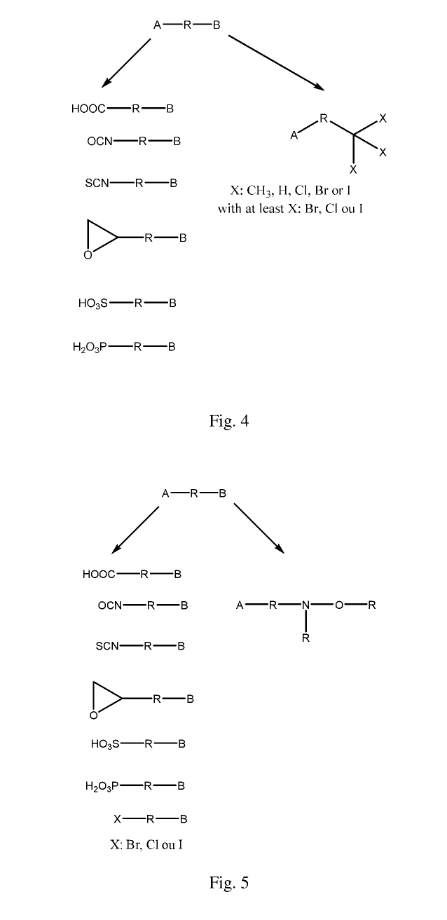

With reference to FIG. 4, the second pathway (ATRP) requires a molecule comprising a function A of the type carboxylic acid or its salts, isocyanate, thioisocyanate, oxirane, sulfonic acid or its salts, phosphonic acid or its salts, which can react with the alcohol group of the NCC—OH; and a function B of halide type, the halide atom being either a fluorine, a chlorine, a bromine or an iodine. The second stage of the ATRP pathway is the radical polymerization of a monomer carrying an anion of lithium salt and a reactive group in the radical polymerization. The reactive group M of the monomer MLiSalt in the radical polymerization can be for example a vinylphenyl substituted in ortho, meta or para position, an acrylate, a methacrylate, an allyl or a vinyl.

With reference to FIG. 5, the third pathway (NMP) brings into play a molecule comprising a function A of the type carboxylic acid and its salts, isocyanate, thioisocyanate, oxirane, sulfonic acid and its salts, phosphonic acid and its salts, or halide (X: Cl, I or Br) that can react with the alcohol group of the NCC—OH; and a function B of the type nitroxide (N—O bond). The second stage of the NMP pathway is the radical polymerization of a monomer carrying an anion of lithium salt and a reactive group in the radical polymerization. The reactive group M of the monomer MLiSalt in the radical polymerization can be for example a vinylphenyl substituted in ortho, meta or para position, an acrylate, a methacrylate, an allyl or a vinyl.

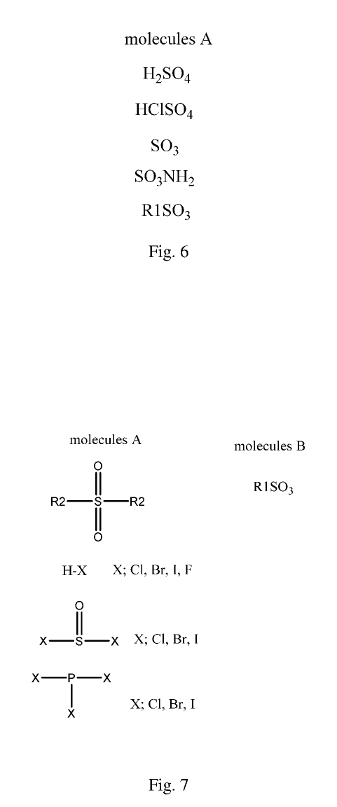

The second synthesis route (2) as previously mentioned is a two-stage process. The first stage is the reaction of the NCC—OH with a molecule A which is of the type sulfuric acid (H₂SO₄), chlorosulfuric acid (HClSO₄), sulfur trioxide (SO₃), sulphamic acid (SO₃NH₂) or sulfate salts (R1SO₃; R1: Na₂ or Mg or K₂ or Li₂ or Be) (FIG. 6). The second stage is the grafting of the anion of the lithium salt. The NCC—O-A previously obtained is reacted with a trifluoromethanesulfonamide (R—SO₂—NH₂) and a lithium salt which may be selected from LiCF₃SO₃, LiB(C₂O₄)₂, LiN(CF₃SO₂)₂, LiC(CF₃SO₂)₃, LiC(CH₃)(CF₃SO₂)₂, LiCH(CF₃SO₂)₂, LiCH₂(CF₃SO₂), LiC₂F₅SO₃, LiN(C₂F₅SO₂)₂, LiN(CF₃SO₂), LiB(CF₃SO₂)₂, LiPF₆, LiSbF₆, LiClO₄, LiSCN, LiAsF₆, LiBOB, LiBF₄, and LiClO₄. Thus, NCC—O-LiSalt is obtained.

The third synthesis route (3) is a three stages process. In the first stage, NCC—OH is reacted with a molecule A (FIG. 7) of the type sulfonate or triflate R2-SO₂—R2 wherein R2 may be linear or cyclic alkyl or aryl or alkyl fluoride, ether, ester, amide, thioether, amine, thiocyanate, perchlorate, quaternary ammonium, urethane, thiourethane, silane, phosphorus or boron or fluorine or chlorine or bromine or idodine, or a mixture of these groups or atoms; or of the type hydracid (hydrogen halide) H—X; thionyl halide SOX₂ or phosphorus halide PX₃ wherein X: Br, Cl, I or F. The second stage is the reaction of the NCC-A previously obtained with a molecule B (FIG. 6) of the type sulfate salt RSO₃ to obtain NCC—SO₃. R may be a linear or cyclic alkyl or aryl or alkyl fluoride, an ether, ester, amide, thioether, amine, quaternary ammonium, urethane, thiourethane, silane or a mixture of these groups. R may also be an hydrogen or a fluorine atom or a chlorine atom or a bromine atom or an iodine atom. In the last stage, NCC—SO₃ is reacted with a trifluoromethanesulfonamide (R—SO₂—NH₂) and a lithium salt which may be selected from LiCF₃SO₃, LiB(C₂O₄)₂, LiN(CF₃SO₂)₂, LiC(CF₃SO₂)₃, LiC(CH₃)(CF₃SO₂)₂, LiCH(CF₃SO₂)₂, LiCH₂(CF₃SO₂), LiC₂F₅SO₃, LiN(C₂F₅SO₂)₂, LiN(CF₃SO₂), LiB(CF₃SO₂)₂, LiPF₆, LiSbF₆, LiClO₄, LiSCN, LiAsF₆, LiBOB, LiBF₄, and LiClO₄. Thus, NCC-LiSalt is obtained.

Tests performed show that the use of a nano-composite comprising poly (ethylene oxide) chains blended with a nanocrystalline cellulose onto which are grafted anions of lithium salt according to the present invention as solid polymer electrolyte in a lithium metal battery leads to an energy storage device having excellent performance and excellent ionic conductivity. The solid polymer electrolyte according to the present invention also has good mechanical strength and durability, and high thermal stability. The use of this solid polymer electrolyte in a lithium metal battery makes it possible to limit dendritic growth of the lithium enabling quick and safe recharging. The solid polymer electrolyte according to the present invention substantially reduces the formation of heterogeneous electrodeposits of lithium (including dendrites) during recharging.

The solid polymer electrolyte 16 is stronger than prior art solid polymer electrolytes and could therefore be made thinner than prior art polymer electrolytes. As outlined above the solid polymer electrolyte 16 may be as thin as 5 microns. A thinner electrolyte in a battery results in a battery having a higher energy density. The increased strength of the blend of the polymer with nanocrystalline cellulose grafted with lithium salt anions may also render the solid polymer electrolyte 16 more stable in processes. The solid polymer electrolyte 16 is more tear resistant and may be less likely to wrinkle in the production process.

In one specific embodiment of the solid polymer electrolyte 16, PEO and lithium salt are mixed together in a ratio of between 70%/W and 90%/W of PEO and between 10%/W and 30%/W of lithium salt. Then nanocrystalline cellulose grafted with anions of the same lithium salt is added to the PEO-Lithium salt complex in a ratio of between 70%/W and 99%/W of PEO-salt complex and between 1%/W and 30%/W of grafted nanocrystalline cellulose. For example, the solid polymer electrolyte 16 blend may consist of 70%/W PEO, 15%/W lithium salt and 15%/W grafted nanocrystalline cellulose.

Modifications and improvement to the above described embodiments of the present invention may become apparent to those skilled in the art. The foregoing description is intended to be exemplary rather than limiting. Furthermore, the dimensions of features of various components that may appear on the drawings are not meant to be limiting, and the size of the components therein can vary from the size that may be portrayed in the figures herein. The scope of the present invention is therefore intended to be limited solely by the scope of the appended claims.

What is claimed is:

1. A nanocrystalline cellulose grafted with anions of lithium salt.

2. The nanocrystalline cellulose of claim 1, wherein the grafted anions are those of the lithium salts selected from the group consisting of SO₂NLiSO₂R, SO₂CLiRSO₂R and SO₂BLiSO₂R.

3. The nanocrystalline cellulose of claim 2 wherein R is either a linear or cyclic alkyl or aryl or alkyl fluoride or ether or ester or amide or thioether or amine or quaternary ammonium or urethane or thiourethane or silane or a mixture of these groups.

4. The nanocrystalline cellulose of claim 2 wherein R is either an hydrogen or a fluorine or a chlorine or a iodine or a bromine atom.

5. The nanocrystalline cellulose of claim 1 wherein the grafted anions of the lithium salt is LiTFSI.

6. A solid polymer electrolyte for a battery, the solid polymer electrolyte including a polymer capable of solvating a lithium salt, a lithium salt, and nanocellulose in the form of nanofibers or nanocrystals onto which are grafted anions of lithium salt.

7. A solid polymer electrolyte as defined in claim 6 wherein the lithium salt LiSalt is selected from the group consisting of LiCF₃SO₃, LiB(C₂O₄)₂, LiN(CF₃SO₂)₂, LiC(CF₃SO₂)₃, LiC(CH₃)(CF₃SO₂)₂, LiCH(CF₃SO₂)₂, LiCH₂(CF₃SO₂), LiC₂F₅SO₃, LiN(C₂F₅SO₂)₂, LiN(CF₃SO₂), LiB(CF₃SO₂)₂, LiPF₆, LiSbF₆, LiClO₄, LiSCN, LiAsF₆, LiBF₄, and LiClO₄.

8. A solid polymer electrolyte as defined in claim 6 wherein the grafted anions on the nanocrystalline cellulose are those of lithium salt selected from the group consisting of SO₂NLiSO₂R, SO₂CLiRSO₂R and SO₂BLiSO₂R.

9. A solid polymer electrolyte as defined in claim 6 wherein the lithium salt is LiTFSI.

10. A solid polymer electrolyte as defined in claim 8 wherein R is either a linear or cyclic alkyl or aryl or alkyl fluoride, an ether, ester, amide, thioether, amine, quaternary ammonium, urethane, thiourethane, silane or a mixture of these groups, R may also be an hydrogen or a fluorine or a chlorine or a iodine or a bromine atom.

11. A solid polymer electrolyte as defined in claim 6, consisting of a nano-composite comprising poly (ethylene oxide) chains blended with a nanocrystalline cellulose onto which are grafted anions of lithium salt.

12. A battery having a plurality of electrochemical cells, each electrochemical cell including a metallic lithium anode, a cathode, and a solid polymer electrolyte positioned between the anode and the cathode, the solid polymer electrolyte including a polymer capable of solvating lithium salt, a lithium salt, and a nanocrystalline cellulose onto which are grafted anions of lithium salt.
